(19) United States
(12) Patent Application Publication
(10) Pub. No.: US 2010/0076579 A1
(43) Pub. Date: Mar. 25, 2010

(54) PERSONALIZED COMPUTER DEVICE AND METHOD FOR ESTABLISHING AN EMOTIONAL ATTACHMENT THEREWITH

(75) Inventor: Baruch NAEH, Tel Aviv (IL)

Correspondence Address: VENABLE LLP, P.O. BOX 34385, WASHINGTON, DC, 20043-9998, US

(73) Assignee: Baruch Naeh-Creative Branding, Ltd,, Tel Aviv-Yafo (IL)

(21) Appl. No.: 12/577,492

(22) Filed: Oct. 12, 2009

Related U.S. Application Data
(63) Continuation-in-part of application No. PCT/IL2008/000487, filed on Apr. 9, 2008.

(30) Foreign Application Priority Data
Apr. 12, 2007 (IL) 182521

(51) Int. Cl. G05B 13/04; G06F 1/20; G06F 17/00; G08B 17/00; G08B 21/00; G08B 23/00; H04B 7/00; G06N 5/02

(52) U.S. Cl. 700/94; 361/679.48; 700/275; 340/584; 340/686.6; 340/573.1; 455/41.2; 706/59; 706/46

(57) ABSTRACT

A personalized computer device comprises a three-dimensional user selectable case with one or more user accessible hardware interfaces localized at a prominent region of the case. To increase heat dissipation despite the variable shape of the case, an intake fan and one or more discharge fans are provided while heat generating components are positioned in the path of the airstream. A reaction generator, such as a sound emitter, light emitter, and a motion actuator, is operable to simulate one or more desired personality traits in response to a predetermined event and in accordance with one or more predetermined reaction parameters. A reaction triggers an emotional response from a user and thereby establishes an emotional attachment between a user and the device.

This application is a continuation-in-part of PCT/IL2008/000487 filed Apr. 9, 2008 which designates the United States, and claims priority of Israeli Patent Application No. 182521 filed Apr. 12, 2007, both of which applications are herein incorporated by reference in their entireties.

### FIELD OF THE INVENTION

The present invention relates to a personalized computer device and peripheral hardware units with which a user may establish an emotional attachment.

### BACKGROUND OF THE INVENTION

Although the various components of a personal computer, and particularly a desktop computer, including the central processing unit (CPU), motherboard, memory card, hard disk, video card, monitor, drives, power supply, keyboard, and pointing device have shown dramatic technological advancement in the past 25 years, the computer case, or the enclosure for the main components of a computer, has generally retained its rectilinear configuration. Since the computer case is rectilinear and usually made of dark metallic materials, many child users relate to a computer as being impersonal, standardized, and uninteresting.

It is therefore an object of the present invention to provide a personalized computer device encasing the mother board and hard disk which will capture the attention of child users and encourage them to interact with a computer.

It is another object of the present invention to provide a personalized workstation that is compatible with the configuration of the computer device.

### SUMMARY OF THE INVENTION

The present invention is directed to a personalized computer device, comprising a three-dimensional user selectable case of varying shape which defines a figure of interest and encloses heat generating components of a personal computer; one or more user accessible hardware interfaces localized at a prominent region of said case; an intake fan by which air is drawn into the interior of said case via an inlet formed in said case; one or more discharge fans by which said drawn air is discharged through corresponding outlets formed in said case, said heat generating components being positioned in the path of an airstream flowing from said intake fan to said one or more discharge fans; and a reaction generator operable to simulate one or more desired personality traits in response to a predetermined event and in accordance with one or more predetermined reaction parameters, whereby to establish an emotional attachment between a user and said device.

The case has a shape selected from a group consisting of animals, plants, people, celebrities, cartoon characters, vehicles, buildings and constructions, natural features, items of apparel, food products, balls, sports equipment, humanoids, robots, literary figures, biblical figures, abstract figures, furniture, household equipment, or any combination thereof.

Although some regions of the case are narrower than those of a prior art rectilinear case and are therefore subject to an increased level of heat generation, the air intake fan is employed to draw air into the case and to thereby increase the rate of heat dissipation by means of forced convection.

In one aspect, each inlet and outlet of the airstream is formed in a portion of the case that is spaced from the prominent region and is therefore not noticeably by the user. For example, the inlet may be formed within a bottom of the case which is located above a leg of the device.

By virtue of the increased heat dissipation, the case may be made of a material selected from a group consisting of polymers, metals, metal alloys, wood, paper, cardboard, clay, glass, composite materials, leather, suede, velvet, textiles, silk, wool, hair, fur, a flexible screen, FOLED, or any combination thereof. The size, shape, color, texture, and material of the case or envelope is individually selectable, customizable and/or formable.

The one or more screens may be provided either in a 2D or 3D orientation, and can be changed on the fly based on external or internal events.

The device may also comprise one or more replaceable and configurable parts which are attachable to the case or to adjacent parts, said parts having a shape selected from a group consisting of eyes, ears, nose, legs, wings, hats, shoes, socks, hats, clothes, decorations, or any combination thereof.

As referred to herein, a “reaction” is any hardware or software operation performed by the device which is normally not performed by a personal computer when a user is interacting therewith during regular data exchange operations and which involves visual, vocal, or movement related emotional effects that result from predetermined programming or in response to stimulations from one or more sensors. The “reaction generator” is the hardware element or software module that initiates the reaction.

The reaction generator comprises a component selected from the group consisting of a sound emitter for enunciating a predetermined voice message, an actuator for initiating displacement of one or more elements operatively associated with the case, artificial intelligence means, means for customizing a displayed computer theme in response with a selected shape of the case, and means for displaying, introducing or emitting audio information, video information, light related information, sounds, or vibrations, or any combination thereof, one or more desired personality traits being simulated by means of the combination of a generated reaction and the shape of the case, so as to trigger an emotional response from the user.

In one embodiment, the reaction generator comprises a sound emitter for enunciating a predetermined voice message, one or more desired personality traits being simulated by means of the combination of sounds emitted from said sound emitter and the shape of the case, so as to trigger an emotional response from the user.

In one embodiment, the reaction generator comprises an actuator for initiating displacement of one or more elements operatively associated with the case, one or more desired personality traits being simulated by means of the combination of said displacement and the shape of the case, so as to trigger an emotional response from the user. The actuator is selected from the group consisting of a piezoelectric device, a vibrator, a pump, a motor, maneuvering means, and transmission. The one or more elements that are displaced by means of the actuator are selected from the group consisting of a support, a foot, a wheel, and a CD tray which is localized at a prominent region of the case and which is elongatable in reaction to a predetermined event.

In one embodiment, the reaction generator comprises a touch sensitive element provided in the prominent region of the case, for generating a predetermined reaction upon being touched. The predetermined reaction is selected from the group consisting of a voice response, a movement response, and a visual response. The touch sensitive element comprises a motion sensor, a piezoelectric device, or is made of touch sensitive resistive or capacitive material.

In one aspect, the touch sensitive element is a replaceable part that is coupled to a USB port, said USB port being accessible to a recessed socket formed in the prominent region of the case.

In one aspect, the touch sensitive element comprises means for changing the color of its surface in response to a contact force applied by the user.

The predetermined reaction parameters define a user modifiable trait profile. The trait profile is modifiable by means of a user selectable menu and a pointing device in communication with a processor of the personal computer or the trait profile is wirelessly modifiable.

In one aspect, the reaction generator is operable to generate a reaction at a predetermined time.

In one aspect, the reaction generator is operable to generate a reaction upon sensing motion or presence of the user. The motion or presence of the user is sensed by means of a voice sensor, a motion sensor, a presence sensor, a heat sensor for sensing body temperature, or a short range transceiver for receiving a signal transmitted by a suitable transmitter carried by the user.

In one aspect, the device comprises wired or wireless communicating means, said communicating means selected from the group consisting of RFID means, Bluetooth means, RF emitter, UV means, IR means, Vis light emitter, Laser emitter, radio transmitters and detectors thereof, networks, lines, internet, and intranet.

The present invention is also directed to a “community”, or a plurality of personalized computer devices and peripheral hardware units that are interrelated. A peripheral hardware unit comprises a three-dimensional user selectable case of varying shape which defines a figure of interest, a reaction generator, and shares at least one common simulated personality trait with the device.

A peripheral hardware unit is selected from group consisting of computers, personal computers, work stations, docking stations, laptops, PDAs, Personal Organizers, Communicators, imagers, screeners, printers, screens, displayers, slide projectors, projectors, modems, cables and communication cables, transformers, a mouse, mouse pads, keyboards, discs, hard disks, floppy disks, disk holders, loudspeakers, disk-on-keys, video sets, monitors, lamps, LEDs, play stations, media centers, projectors, telephones, cellular telephones, pagers, operators, servers, communication and power sockets, antennas, CD players, TV sets, radios, furniture, bags and carriages, or any combination thereof.

In one aspect, the at least one peripheral hardware units comprises wired or wireless communicating means for identifying each peripheral hardware unit, for communicating with the device, and for thereby acquiring a personality trait of the device.

In one embodiment, a personalized computer device comprises a personal computer comprising processing means, motherboard, hard disk, and one or more user accessible hardware interfaces; a user selectable, customizable and/or formable envelope enclosing said processing means, motherboard, and hard disk, said envelope designed in such a way that normal operation of said device by means of said one or more hardware interfaces remains unhindered; and sound emitting means, one or more desired personality traits being simulated by means of the combination of envelope shape and sounds emitted from said sound emitting means, whereby to establish an emotional attachment between a user and said device.

In one embodiment, the device further comprises anchoring means for securing the envelope to a personal computer frame, said anchoring means being selected from a group consisting of magnets, screws, hooks, zippers, fasteners, clips, flaps, claspers, springs, grips, Velcro™, straps, strings, wires, cables, tabs, poppers, nails, buttons, brackets, or any combination thereof.

In one aspect, the envelope is at least partially continuous and/or impermeable, and comprises at least one aperture, net-like or mesh-like opening.

In one aspect, the device comprises a reaction generator.

The present invention is also directed to a method for establishing an emotional attachment between a user and a personalized computer device, comprising the steps of selecting or customizing a case of a computer device which encloses its processing means, motherboard, and hard disk, and performing a device caused reaction in response to a predetermined event and in accordance with one or more predetermined reaction parameters, wherein said reaction simulates one or more desired personality traits that triggers an emotional response from a user and thereby establishes an emotional attachment between a user and the device.

In one aspect, the device caused reaction is selected from the group consisting of sound emission, light emission, video display, vibration emission, motor actuation, pump actuation, displacement of one or more elements operatively associated with the case, and customization of a displayed computer theme.

In one aspect, the one or more reaction parameters are acquired by communication means.

It is another embodiment of the invention to provide a method for packaging a device, especially a PC, or peripheral hardware with a personalized computer or peripheral hardware, package. This method comprising steps of obtaining a personalized computer or peripheral hardware package as defined in any of the above; and package said computer or peripheral hardware by said package.

It is another embodiment of the invention to provide a method of advertising on computers and peripheral hardware. This method comprising steps of obtaining a personalized device, package as defined in any of the above; said package comprising at least one advertisement; and package said computer by said package.

It is another embodiment of the invention to provide a method for communicating between personalized computer devices and peripheral hardware units in either one or more or networked communities, of intercommunicated computers and peripheral hardware.

### BRIEF DESCRIPTION OF THE DRAWINGS

In the drawings:

FIGS. 1-16 illustrate a plurality of embodiments of a computer device according to the present invention;

FIG. 17 is a perspective view of a device according to another embodiment of the invention;

FIG. 18 is a perspective, median cross sectional view of the device of FIG. 17, showing an airstream that flows through the interior of the case;

FIG. 19 is a perspective, horizontal cross sectional view of the device of FIG. 17, showing the flow of an airstream for dissipating heat generated by components of the device;

FIG. 20 is a coronal cross sectional view of the device of FIG. 17, showing a vertically disposed panel on which are mounted a plurality of connectors;

FIG. 21 is a perspective view of a device according to another embodiment of the invention;

FIG. 22 is a rear view of the device of FIG. 21;

FIG. 23 is a perspective, median cross sectional view of the device of FIG. 21, showing the mounting of various components thereto;

FIG. 24 is a perspective view of a showroom in which a plurality of computer devices are peripheral hardware units are displayed and sold;

FIGS. 25 and 26 is a front view of a plurality of peripheral hardware units;

FIG. 27 is a flow diagram illustrating a method for establishing emotional attachment between a child user and a computer device, according to one embodiment of the invention; and

FIG. 28 is a block diagram illustrating the transmission of personality traits within a community.

### DETAILED DESCRIPTION OF PREFERRED EMBODIMENTS

The present invention is a novel computer device that is personalized according to the interests of a child user to such a degree that the child user establishes an emotional attachment with the computer device. The computer device (hereinafter referred to as a “device” for brevity) is provided with a case for the main components of the device, which is configured in the shape of a three dimensional figure of interest to the child user. To establish the emotional connection, the device may emit voice messages having voice patterns and tones uniquely associated with the figure of interest. Different voice messages may be emitted at predetermined times in order, for example, to wish a happy birthday greeting or to encourage the child user to wear warm clothes. Also, icons suggestive of the figure may be displayed on the monitor. The device may also be interactive in the sense that it reacts to a motion of the child user by changing its shape, moving, being illuminated at a specific region, or emitting a voice message. The child user will willingly operate the computer after the emotional attachment has been established.

The device may be configured such that its user accessible hardware interfaces, including activation buttons, an optical disk drive, a memory card reader, USB ports, and auxiliary ports e.g. for a microphone or speaker, are localized at a prominent region of the device. When the device is shaped as a humanoid or an animal, the prominent region is the head or in the vicinity of the head. When the device is otherwise configured, the prominent region is one that is immediately noticeable and accessible by a child user. The user accessible hardware interfaces are built in to the prominent region so as to be harmonized with one of its features, to further increase the enjoyment of the child user. The cables, e.g. monitor cable and power cable, extending from the device may also be harmonized with the configuration of the case, for example resembling a tail of an animal.

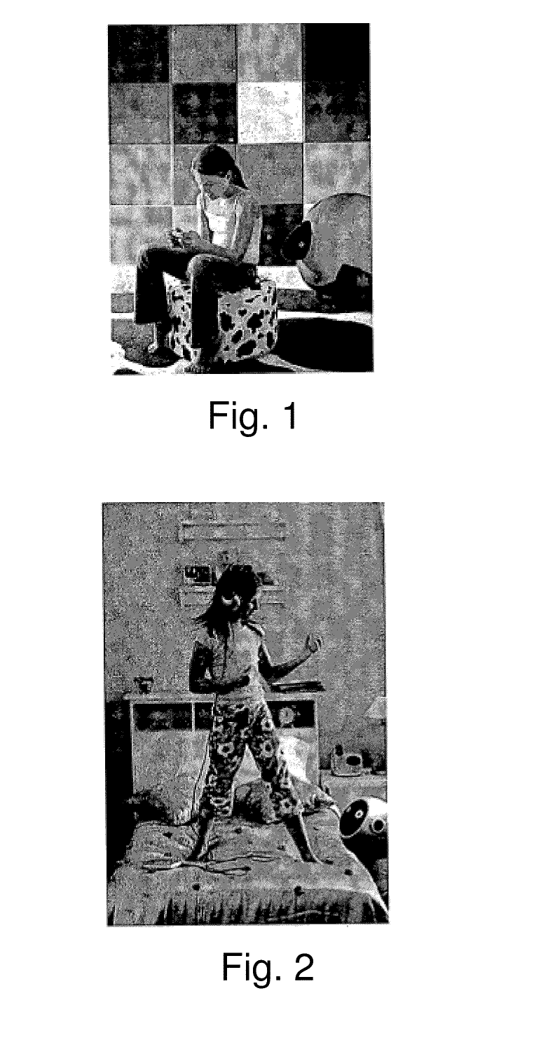

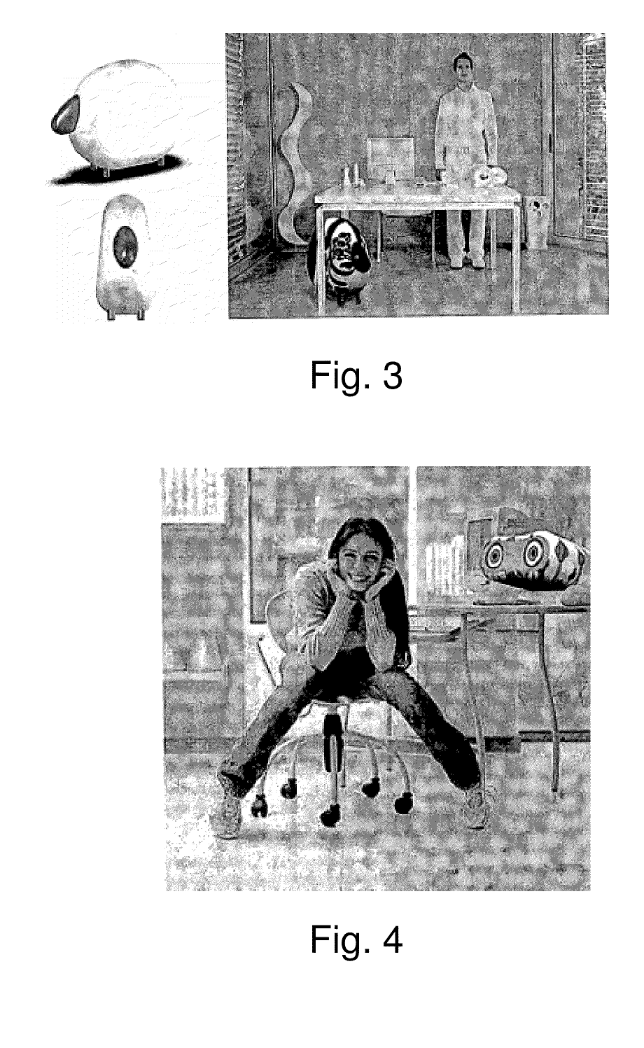

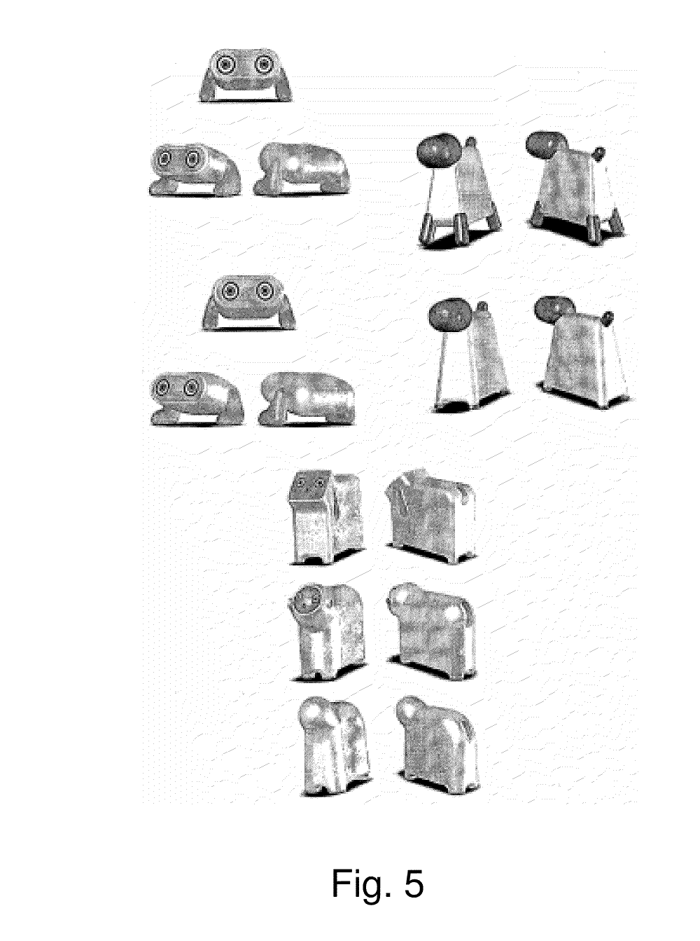

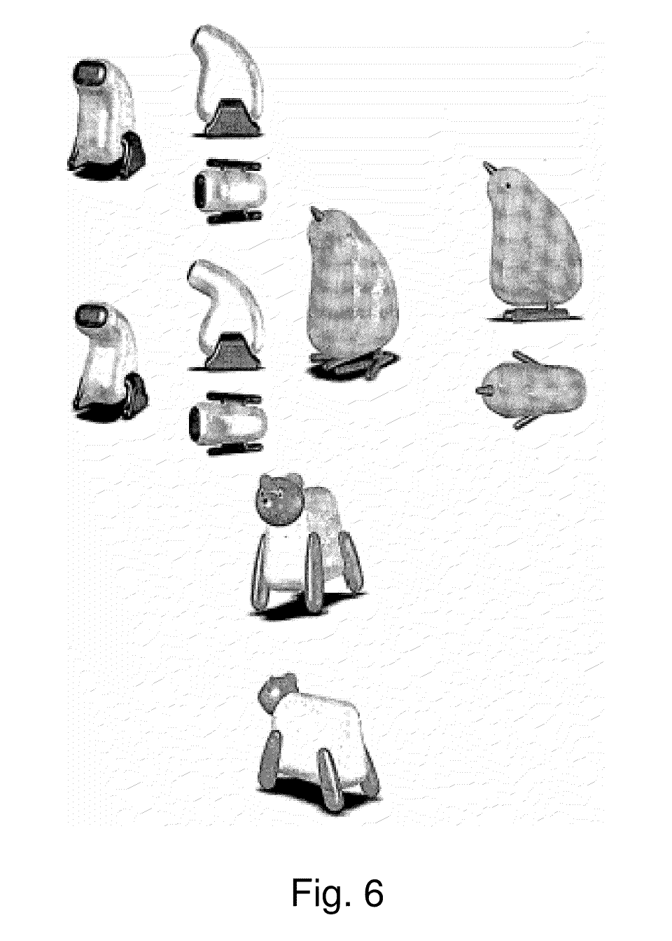

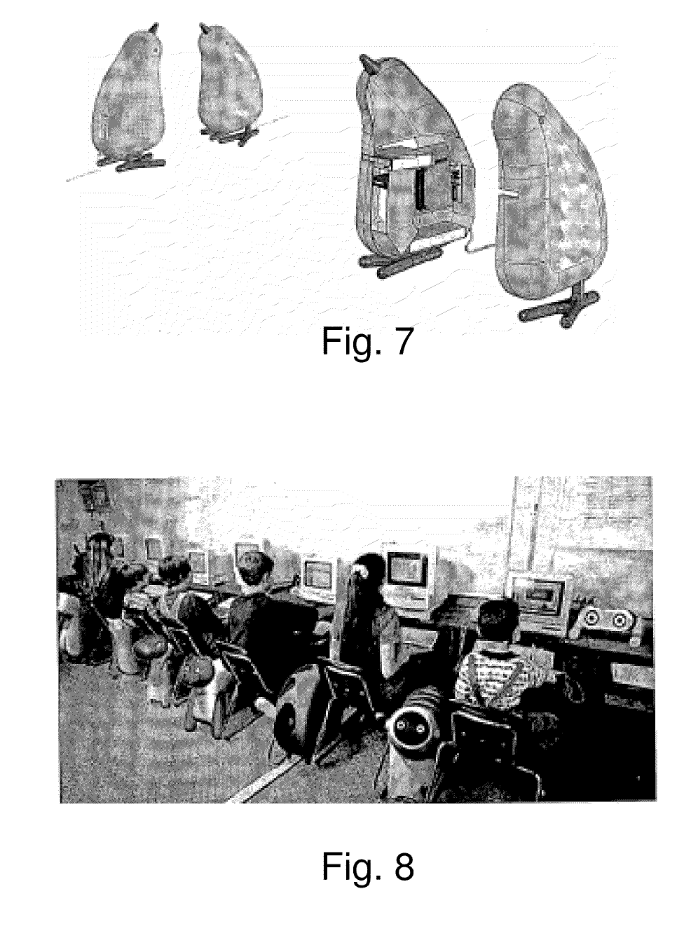

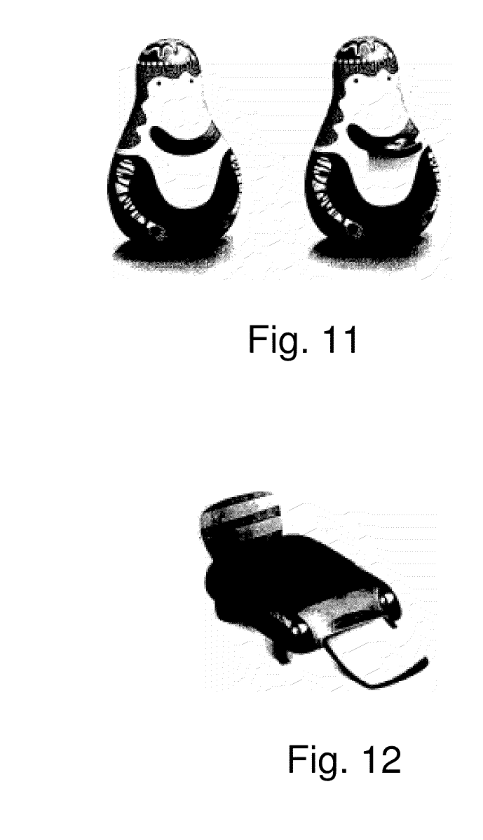

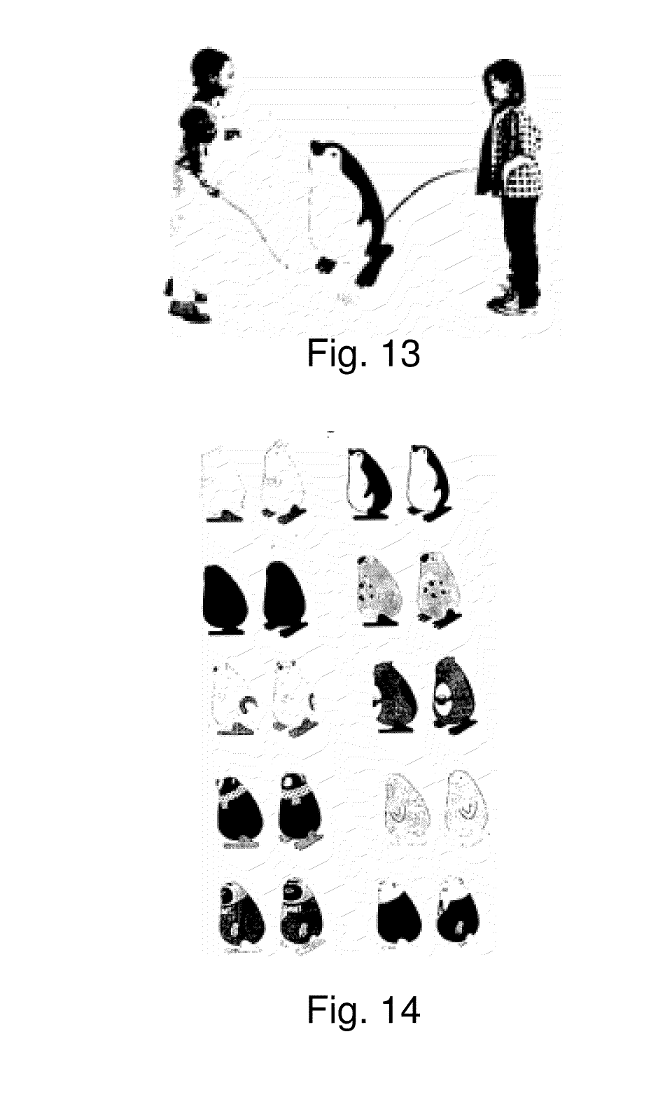

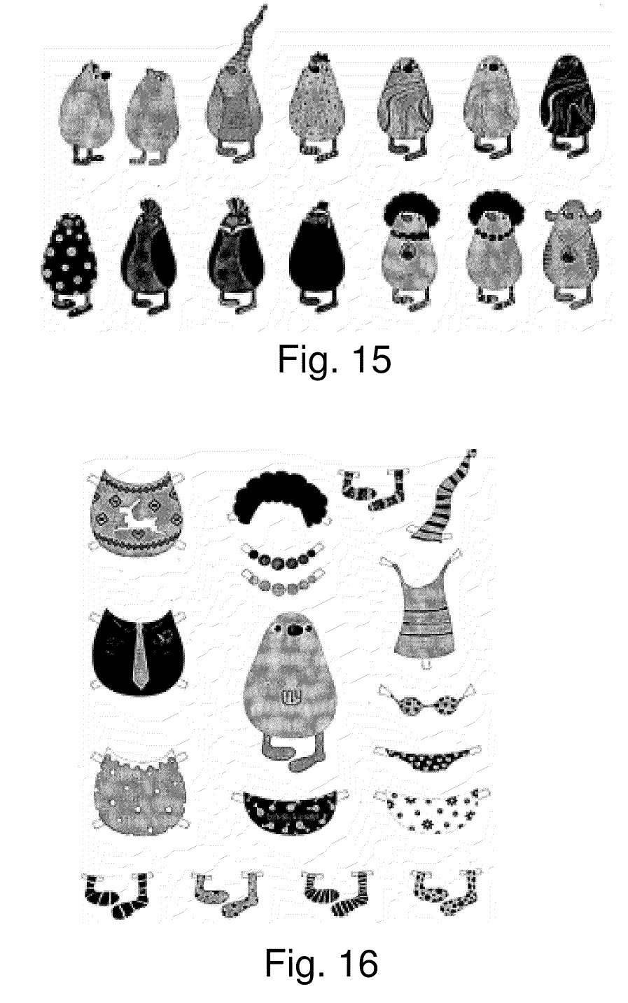

Reference is made to FIGS. 1-16, which illustrate a set of out-of-scale embodiments of the invention.

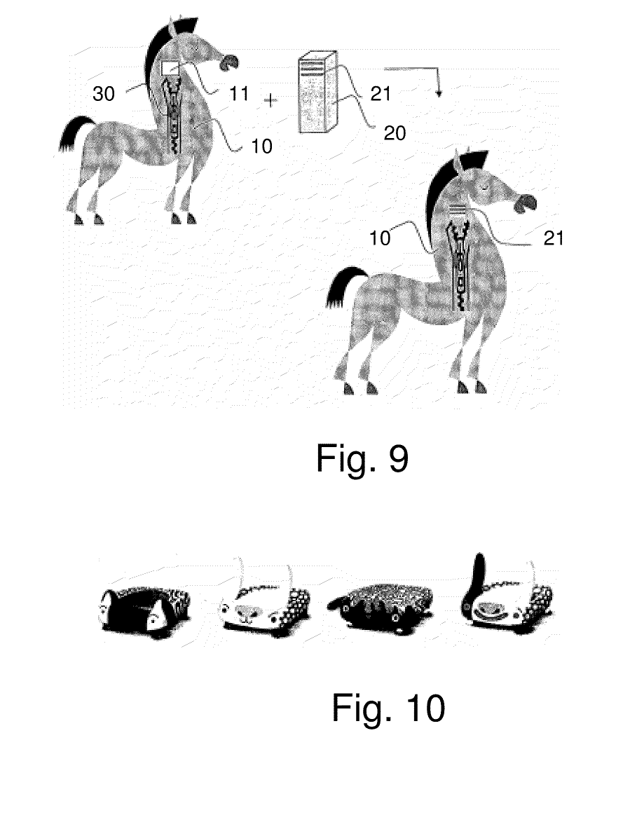

An exemplary device is schematically illustrated in FIG. 9, showing an out-of-scale embodiment wherein a case 20 is accommodated inside a horse shaped envelope 10. Envelope 10 is furnished with a zipper or closure 30 through which case 20 may be inserted or withdrawn and an upper service opening 11 corresponding to the computer service and control fascia 21 such that normal operation of the computer remains unhindered.

In this embodiment the device comprises: (i) an envelope having a design suitable for enclosing at least a portion of the case; the envelope is adapted to be designed by the consumer of the device in a personal and/or emotional manner; (ii) anchoring means, adapted to secure the envelope to the case, wherein the design, i.e., the envelope's size, shape, color, texture, and material is individually selectable, customizable and/or formable by the consumer; (iii) replaceable parts that can be added to the device and change its nature; those parts can be without limitations eyes, ears, nose, mouth, legs, hands, wings, shoes, socks, hats, clothes, and decorations.

In FIGS. 14-16 are shown examples, provided in a non-limiting manner, of devices employing add-on parts. All of these devices have a substantially identically shaped base envelope, to which is added in a personalized manner one or more different add-on parts to produce a different figure.

It will be appreciated that when the device comprises a user selected or customized shaped case, add-on parts can also be attached to the case.

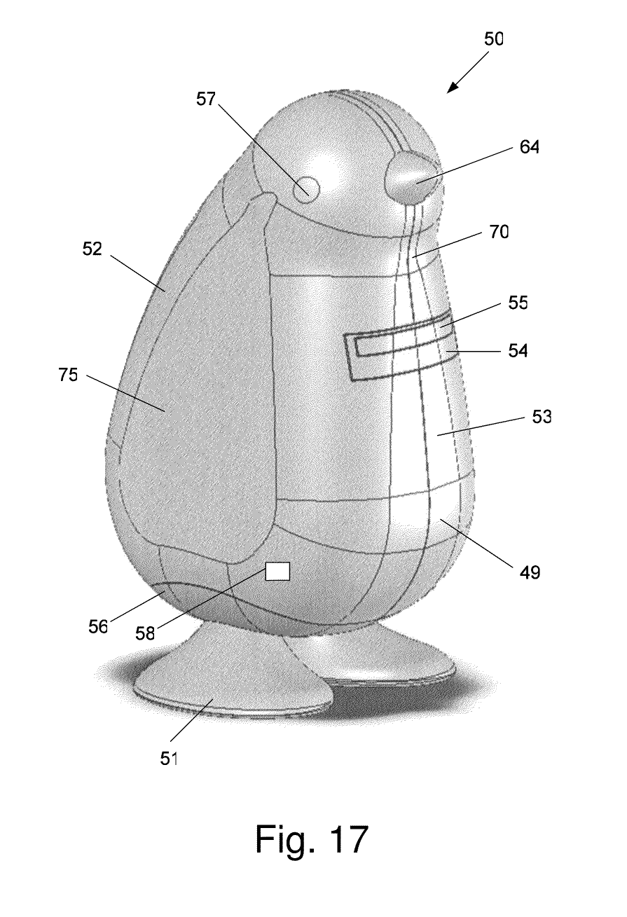

A chicken shaped device 50 is illustrated in FIG. 17. As shown, case 52 is formed with a service opening 54 in a central portion of body 53, at the front of the case. Cover 55 for the CD drive is accessible through service opening 54. Activation button 57 for device 50 is positioned above CD drive cover 55, appearing as the eye of the figure. As will be appreciated, all other hardware interfaces of the device that are accessible by a child user are positioned in the vicinity of the head of the figure.

Both an anchored envelope and a user selected or customized case can be made of materials such as polymers, metals, metal alloys, wood, paper, cardboard, clay, glass, composite materials, leather, suede, velvet, textiles, silk, wool, hairs, fur, or any combination thereof.

Device 50 may be provided with two supports 51 in the shape of a foot. Each foot 51 may be adapted to move by means of an actuator 58, such as a piezoelectric device, a vibrator, motor, and maneuvering means including transmission. When device 50 is displaced during movement of feet 51, especially in response to an operation initiated by a child user, the child user acquires an affinity and emotional attachment for the device. For example, device 50 may comprise a motion sensor 56 operable such that a reciprocating up and down movement similar to jumping may be initiated when the movement of the child user has been sensed for a first time following a predetermined lapse. Alternatively, the presence of the child user may be sensed by means of a short range transceiver 49, e.g. a Bluetooth transceiver, which is adapted to receive a signal transmitted by a suitable transmitter carried by the child user, e.g. a transmitter embedded in a cellular telephone or any other wireless device carried by the child user. A foot displacement may be accompanied by the illumination of an element positioned in the prominent region, e.g. nose 64, the enunciation of a predetermined voice message by means of a voice emitter 70, e.g. “Welcome home Jerry,” or the display of video images on a side region 75 of case 52. It is therefore anticipated that a child user experiencing the joy of being welcomed by device 50 after returning home after school will willingly interact with the device to complete his homework or to perform any other required assignment.

In contrast to prior art cases which are generally rectilinear, the case of the present invention is curvilinear, such as case 52 of device 50, or may be of varying shape. Thus some regions of the case are narrower than those of the prior art rectilinear case, and are therefore subject to an increased level of heat generation. In order to increase the heat dissipation capabilities of the present invention, an air intake fan is employed to draw air into the case and to thereby increase the rate of heat dissipation by means of forced convection.

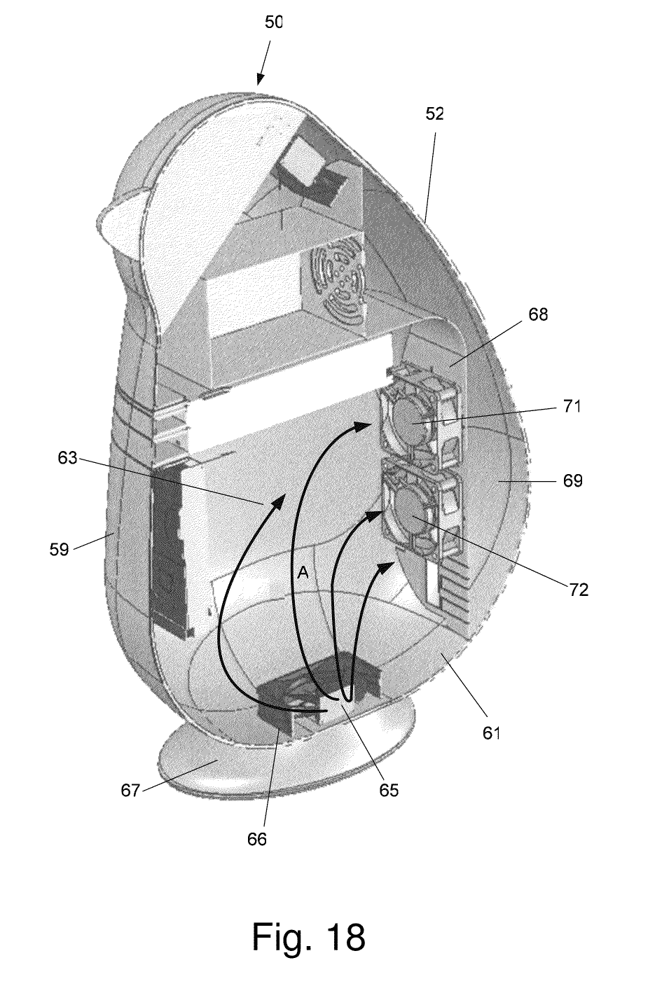

As shown in FIG. 18, case 52 of device 60 is provided with an inlet 65 through which air is drawn by means of intake fan 66. Inlet 65 is advantageously formed within bottom 61 of case 62 and above leg 67, so as not to be visible by a child user viewing front 59 of device 60. The heat transferred to the intake air may be discharged from case 62 by means of one or two discharge fans 71 and 72, depending on the level of heat that is generated in case 52, the discharge fans being rotatably mounted on vertical panel 68 attached to, or formed integrally with, case 52. The heated air is discharged through two openings downstream of discharge fans 71 and 72, respectively, and formed in rear wall 69 of case 62. Proper positioning of intake fan 66 and discharge fans 71 and 72 produces an airstream A that is adapted to flow along a desired path through interior 63 of case 52 and to optimally dissipate the heat generated by the components of device 60.

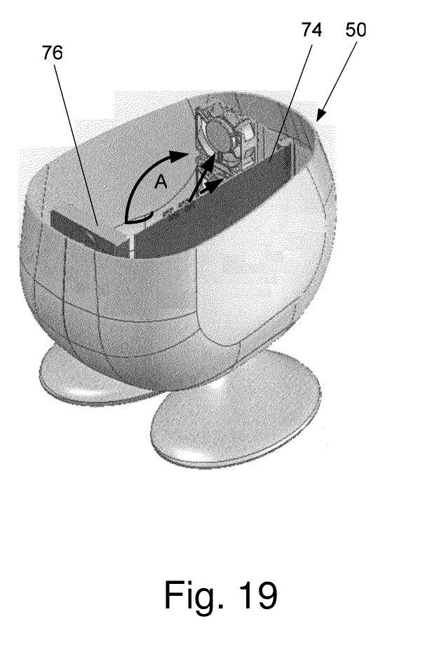

As shown in FIG. 19, heat generating components of device 60, particularly motherboard 74 and CPU 76, are mounted along the path of airstream A so that the generated heat will be dissipated.

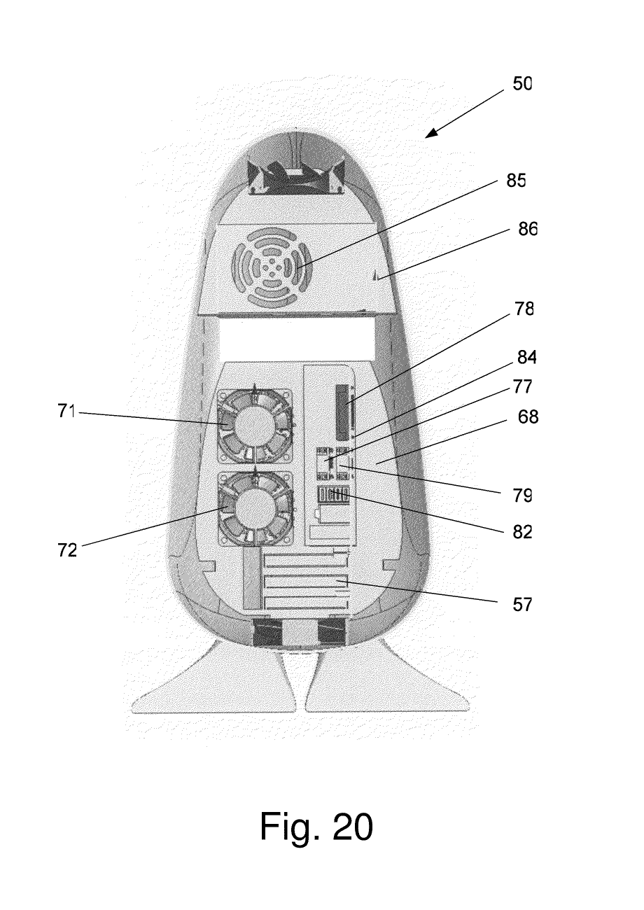

Vertical panel 68 is illustrated in FIG. 20. In addition to discharge fans 71 and 72 being mounted on panel 68, various connectors, such as a power line connector, keyboard connector 77, parallel port 78, video output connector 79, USB ports 82 such as for a mouse, and speaker connector 84, are secured to panel 68. A plurality of hardware slots 57 such as for additional memory may be formed in a bottom region of vertical panel 68. A second panel 86 is provided above panel 68, and an outlet 85 for the integral fan of the power supply is formed in second panel 86.

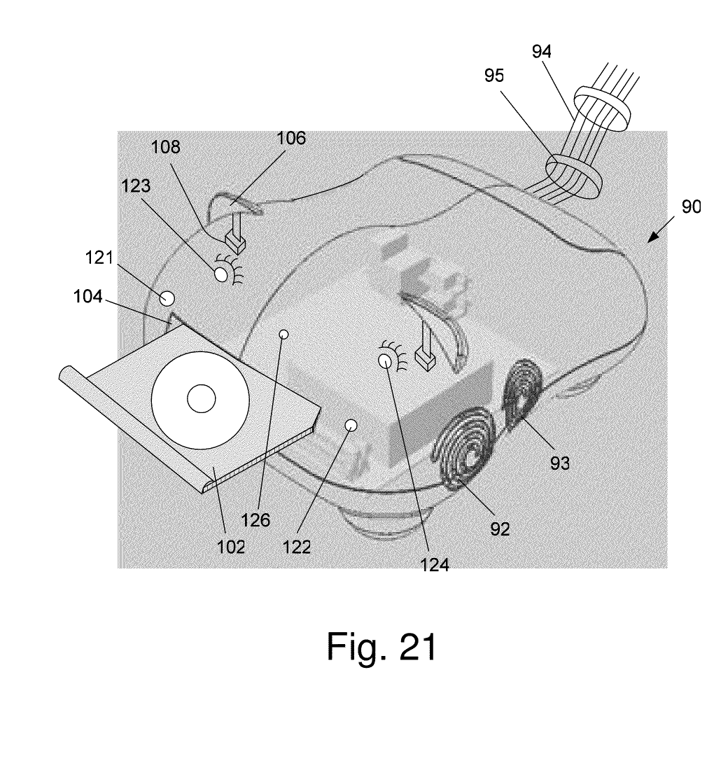

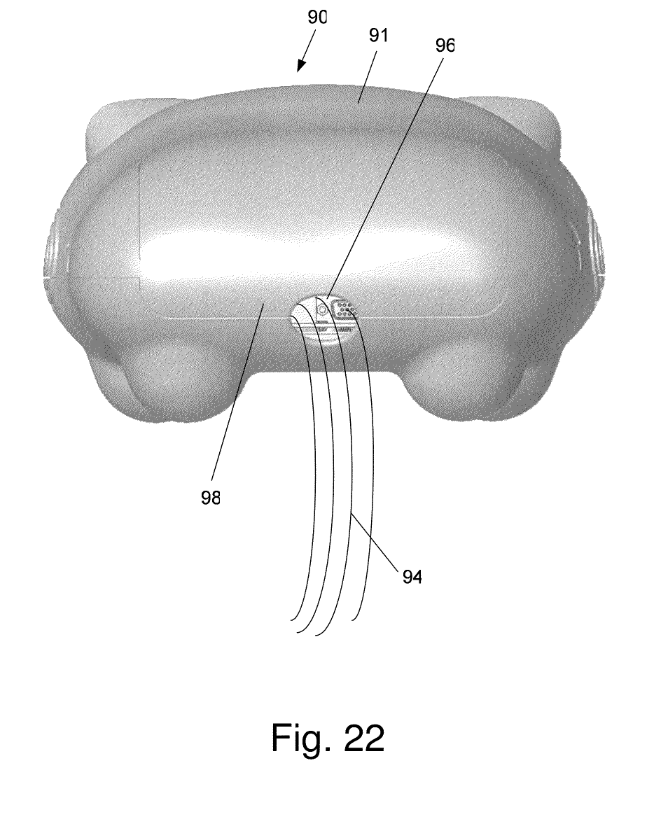

A device 90 having a dog shaped case 91 is illustrated in FIG. 21. User accessible hardware interfaces 121-124 are positioned in a prominent region of case 91. A LED 126 for indicating operation of device 90 is also positioned in a prominent region of case 91. Openings 92 and 93 for the discharge fans are harmonized in the side of the figure. A plurality of cords 94 are guided through aperture 96 formed in a central region of the rear 98 of case 91, as shown in FIG. 22. One or two bands 95 may be secured to the plurality of cords 94, to provide the appearance of a tail.

A tray 102 for a CD drive is positioned in a region 104 of case 91 which resembles the mouth of the dog shaped figure. Device 90 is operable to cause tray 102 to open at a predetermined time or in response to a predetermined event, even if the tray is not used to load a compact disk. The elongation of tray 102 with respect to mouth 104 provides the child user with the sensation that device 90 is sticking out its tongue and is interacting with him. Tray 102 may be elongated every time that device 90 emits a voice message or every time the child user enters the room in which device 90 is located. Alternatively, tray 102 may be elongated after the child user touches a touch-sensitive region 106 of the device. Touch-sensitive region 106, which is shown to be an ear of the dog shaped case 91 but can be any other element positioned in the prominent region of device 90, may be a replaceable part coupled to a USB port 108 that is accessible to a recessed socket formed in the prominent region, or alternatively, may be permanently attached to case 91. Touch-sensitive region 106 may comprise a motion sensor, a piezoelectric device, or may be made of touch sensitive resistive or capacitive material. Touch-sensitive region 106 may also have means for changing the color of its surface depending on the contact force applied by the child user.

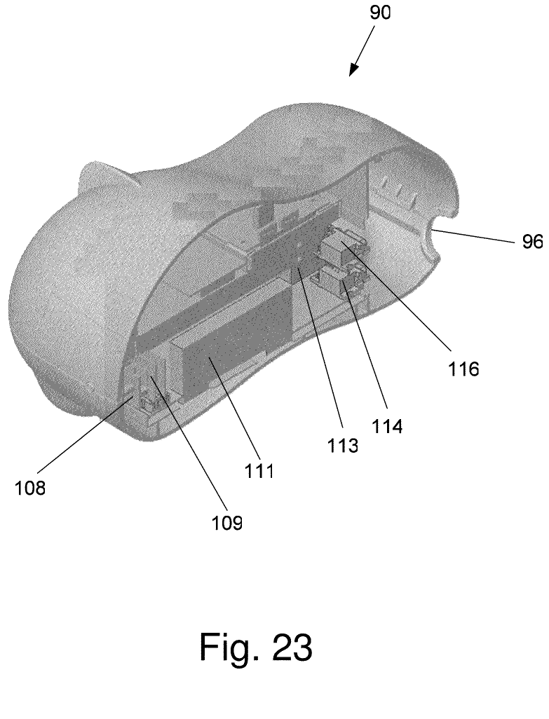

A section of device 90 is illustrated in FIG. 23. An exemplary configuration of voice card 108, video card 109, memory card 111, mother board 113, parallel port 114, and video output connector 116 are shown. Parallel port 114 and video output connector 116 are shown to be accessible to aperture 96 for guiding the plurality of cords. An external power supply may be employed due to the relatively small thickness of the case and the resulting relatively high level of heat generation, and if an internal power supply is used, the corresponding connector will also be accessible to aperture 96.

An important aspect of the present invention is the ability to establish an emotional connection between the child user and device. The establishment of the emotional attachment is contingent on a suitable selection of a device.

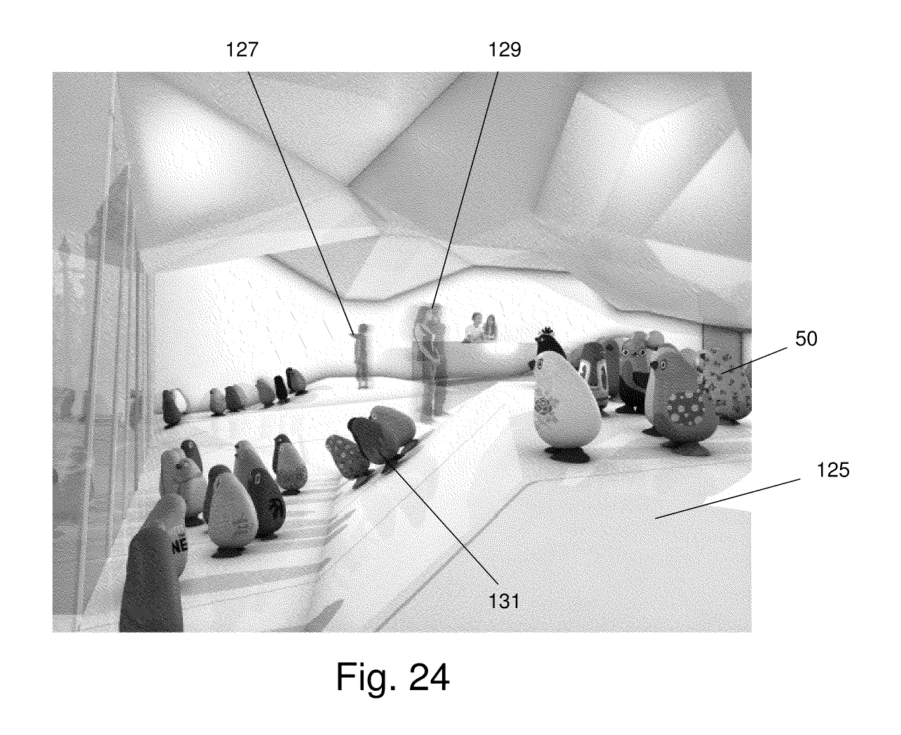

As shown in FIG. 24, a plurality of devices 50 are displayed in a showroom 125, and each of which may have a different shape, color, and size, and may emit a different voice pattern. Exemplary configurations of a case include plants, games, humanoids, celebrities, cartoon characters, vehicles, buildings and constructions, natural features, items of apparel, food products, balls, sports equipment, robots, literary figures, biblical figures, abstract figures, furniture, and household equipment.

As a child user 127 wanders through showroom 125, often accompanied by parents 129, he selects a device of interest. Whether knowingly or not, child user 127 may select a device based on certain personality traits imparted thereto by the combination of one or more of appearance and motion of the device, and voice messages and sound patterns emitted by the device. Child user 127 may select a device having a personality trait with which he is accustomed or with which he aspires to socialize. Exemplary personality traits that are imparted to the device may include happiness, shyness, irritableness, wisdom, loudness, friendliness, and sensitivity. The child user may perceive the personality trait by means of the speech pattern, type of laughter, or any other type of sound emitted by the device. Alternatively or in addition, the child user may perceive a personality trait by means of an audio-visual reaction carried out by the device.

In addition to the plurality of devices, peripheral hardware units 131 (hereinafter “units”) may also be displayed in showroom 125. Each unit 131 is imparted with a personality trait by means of the shape of a case or an anchored envelope, which may be similar or identical to the case of a device, a unique motion, the emission of voice messages or sound patterns, an audio-visual reaction, or a combination thereof. Child user 127 may enjoy using a workstation that comprises a device and a plurality of units that have at least one common personality trait.

Exemplary units include computers, personal computers, work stations, docking stations, laptops, PDAs, Personal Organizers, Communicators, imagers, screeners, printers, screens, displayers, slide projectors, projectors, modems, cables and communication cables, transformers, mice or other pointing devices, mouse pads, keyboards, discs, hard disks, floppy disks, disk holders, loudspeakers, disk-on-keys, video sets, monitors, lamps, LEDs, play stations, media centers, projectors, external speakers, telephones, cellular telephones, pagers, operators, servers, communication and power sockets, antennas, CD players, TV sets, radios, furniture, bags and carriages, or any combination thereof.

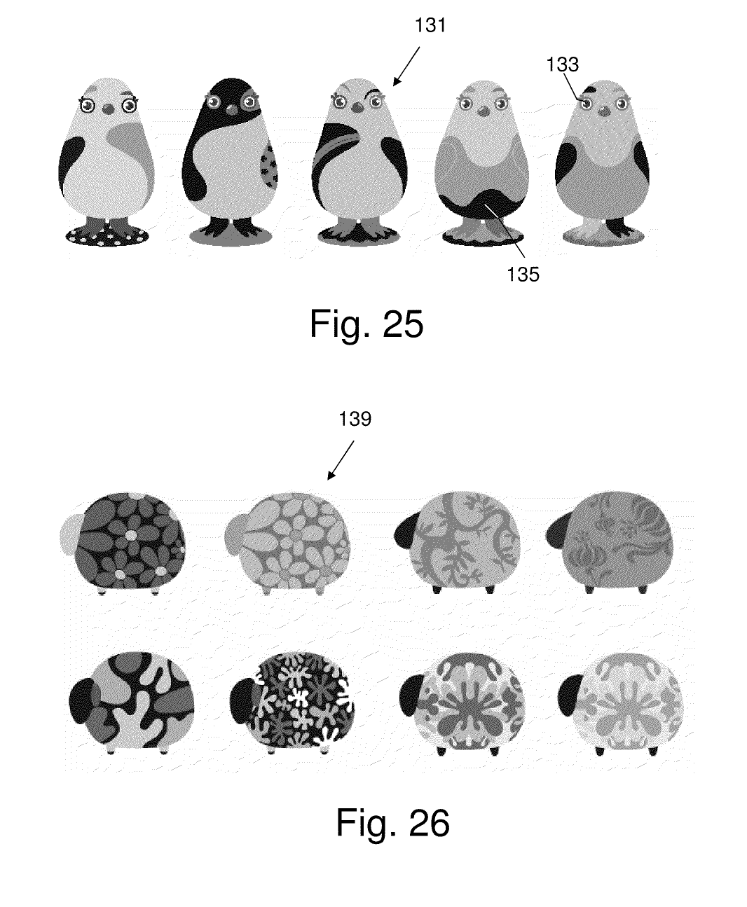

For example, the unit may be an external speaker shaped as a chicken 131 in FIG. 25 or shaped as a sheep 139 in FIG. 26. The external speaker may have more than one loudspeaker, each of which being harmonized with one of the features that are localized at the prominent region of the figure. Unit 131 may comprise a tweeter 133 localized at the eye of the figure and a woofer 135 localized at the stomach of the figure.

Once a desired device is selected, an emotional attachment between the child user and device becomes established. As the device comprises a reaction generator, such as a motion actuator, a light emitter, and a sound emitter, which is programmed to operate in reaction to a predetermined event and in accordance with one or more predetermined reaction parameters in order to simulate desired personality traits, the child user perceives that the device is a true friend. For example, the device processor may be programmed in conjunction with its internal clock to enunciate a voice message at a predetermined time, such as a “Happy Birthday” greeting on the birthday of the child user. The device processor may be programmed to command a device Bluetooth transceiver to transmit a signal to an activation device, such as an activation device for closing lights or an electric blind after having enunciating a “Good Night” greeting at a predetermined time. Additionally, the device processor may be linked to a weather website so that a voice message to wear warm clothes may be enunciated at a predetermined time if the ambient temperature is less than a predetermined threshold. Additionally, a predetermined reaction such as laughter may be effected when the child user touches or pets a predetermined touch sensitive region of the device, such as underneath the neck. For some children a strong bond may be established between the child user and device to such a degree that the device may be an inseparable companion to the child user, similar to the relation of a child to a dog. When the reaction generator includes a motor which drives wheels that move in the direction of the child user, the inseparability between the child user and device becomes more pronounced.

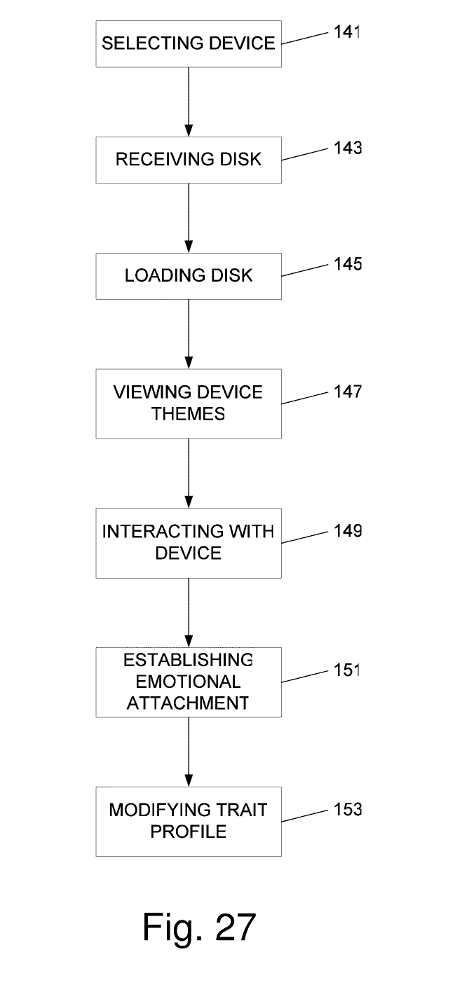

In one embodiment of the invention illustrated in FIG. 27, the theme of the computer is caused to resemble or to be associated with the shape of the device case. After a device having a desired shape is selected in step 141, an optical disk in which is stored a desired personality trait profile is received in step 143. When the disk is loaded in the optical disk drive in step 145, the desired personality trait profile is transmitted to the device processor. Also, a computer code module such as a DLL file or an OCX file is linked to the device operating system at run time so that the theme of the computer displayed on a monitor is caused to resemble or to be associated with the shape of the device case in step 147. That is, the cursor, dialog boxes, windows, pop-up messages such as an antivirus alert, and icons will be changed to resemble or to be associated with the shape of the device case. For example, if the selected device is dog shaped, the icons and dialog boxes may be dog shaped while the cursor may be bone shaped. The continuous association with the device while the child user interacts with the computer while doing homework or roaming the Internet in step 149 will further strengthen the emotional attachment between the child user and device in step 151. If, however, the child user has not developed an affinity for the currently stored personality trait profile of the device, the trait profile may be modified in step 153 by interacting with a menu.

In another embodiment of the invention, one or more personality traits may be transmitted between a device and a peripheral hardware unit, or between a unit and a device. In order to establish a community of devices and units sharing at least one common predetermined personality trait or parameter, the devices and units are provided with communicating means.

The communicating means are adapted to identify a specific device and unit and/or to identify the user/owner thereof. Such communicating means are selected in a non-limiting manner from RFID, Bluetooth, RF emitter, UV, IR Vis light emitter, Laser emitter, radio transmitters and detectors thereof. A device and unit may comprise wireless or wired communicating means, and may communicate via networks, lines, internet, and intranet. The personalized devices and units therefore comprise processing means and retrievable databases adapted to communicate with other personalized devices and units, to acquire a personality, verified identity, to store, process and communicate personality traits with ever changing community or communities of other personalized devices and units sharing at least one common predetermined parameter.

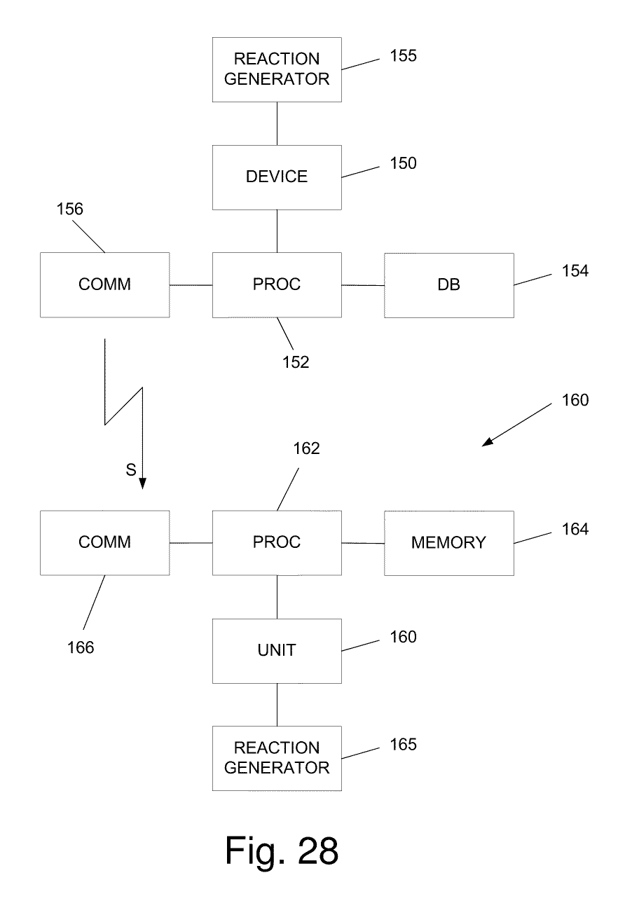

FIG. 28 illustrates the transmission of a personality profile between a device 150 and unit 160 of a community 160. The personality profile of device 150 is stored in database 154, and the device processor 152 commands thereby reaction generator 155 to cause the device to perform a predetermined reaction. Following initiation by a user, a signal S indicative of a set of personality traits is transmitted from communicating means 156 of device 150 to communicating means 166 of unit 160. Unit processor 162 stores the transmitted set of personality traits to memory 164 and commands reaction generator 165 of unit 160 to perform a predetermined reaction.

Hence for example, a given plurality of one or more laptop computer C and/or any other peripheral hardware PHj is characterized by its owner I with a personality Ip. Computer Cj and peripheral hardware PHj stores said personality IP and continuously emits RFID signals to their environment. In case that other laptop computer Cj of owner J is located adjust to C, and in case C and Cj are of similar personality, computers C and Cj will signal their user the existence of other member of the community in the area, and personalized communication massages will either automatically, semi-automatically or manually transfer from Cj to Cj and vice versa, and/or from owner I to owner J and vice versa. Another example is that the community called e.g., Harry Potter™ Community (TPC). Owner I personalizes his computer to the character of Ron Weasley™. Owner J personalizes her cellular telephone to the character of Hermione Granger™. Attraction is provided between I and J. In contrast, Owner K personalizes his computer to the character of Harry Potter™. Owner L personalizes his telephone to the character of Draco Malfoy™. Attraction will be between I, J and K (the Gryffindor™ community) whereas competition will be between I, J, K vs L (the Slytherin™ community).

It is also in the scope of the present invention wherein personalized devices and peripheral hardware are registered to one or more communities in either a direct manner (e.g., tailor-made personalization of the device) and/or indirect manner (e.g., via registration in an internet web-based database).

It is further in the scope of the present invention wherein personalized devices and peripheral hardware are select attraction and competition reactions with other computers and peripheral hardware or same or other communities in either (i) direct manner (e.g., tailor-made personalization of the device) and/or indirect manner (e.g., via registration in an internet web-based database), so as an automatic, semi-automatic, manual or other (at least partially random, in a manner based upon artificial intelligence and computerized reflexes etc) reaction is provided.

It should be noted that although specific examples and embodiments use the term “child user”, the invention is not limited by any means to the age of the user. The invention may be carried out and provide all the advantages and benefits specified above for users of all ages, including, infants, toddlers, children, youngsters, adolescents, and adults.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A personalized computer device, comprising:
a) a three-dimensional user selectable case of varying shape which defines a figure of interest and encloses heat generating components of a personal computer;
b) one or more user accessible hardware interfaces localized at a prominent region of said case;
c) an intake fan by which air is drawn into the interior of said case via an inlet formed in said case;
d) one or more discharge fans by which said drawn air is discharged through corresponding outlets formed in said case, said heat generating components being positioned in the path of an airstream flowing from said intake fan to said one or more discharge fans; and
e) a reaction generator operable to simulate one or more desired personality traits in response to a predetermined event and in accordance with one or more predetermined reaction parameters, whereby to establish an emotional attachment between a user and said device.

2. The personalized device according to claim 1, wherein the reaction generator comprises a component selected from the group consisting of a sound emitter for enunciating a predetermined voice message, an actuator for initiating displacement of one or more elements operatively associated with the case, artificial intelligence means, means for customizing a displayed computer theme in response with a selected shape of the case, and means for displaying, introducing or emitting audio information, video information, light related information, sounds, or vibrations, or any combination thereof, one or more desired personality traits being simulated by means of the combination of a generated reaction and the shape of the case, so as to trigger an emotional response from the user.

3. The personalized device according to claim 2, wherein the actuator is selected from the group consisting of a piezoelectric device, a vibrator, a pump, a motor, maneuvering means, and transmission and the one or more elements that are displaced by means of the actuator are selected from the group consisting of a support, a foot, a wheel, and a CD tray which is localized at a prominent region of the case and which is elongatable in reaction to a predetermined event.

4. The personalized device according to claim 1, wherein the reaction generator comprises a touch sensitive element provided in the prominent region of the case, for generating a predetermined reaction upon being touched, said predetermined reaction being selected from the group consisting of a voice response, a movement response, and a visual response.

5. The personalized device according to claim 4, wherein the touch sensitive element comprises a component selected from the group consisting of a motion sensor, a piezoelectric device, and means for changing the color of its surface in response to a contact force applied by the user, or is made of touch sensitive resistive or capacitive material.

6. The personalized device according to claim 4, wherein the touch sensitive element is a replaceable part that is coupled to a USB port, said USB port being accessible to a recessed socket formed in the prominent region of the case.

7. The personalized device according to claim 1, wherein each inlet and outlet of the airstream is formed in a portion of the case that is spaced from the prominent region.

8. The personalized device according to claim 7, wherein the inlet is formed within a bottom of the case which is located above a leg of the device.

9. The personalized device according to claim 1, wherein the predetermined reaction parameters define a user modifiable trait profile.

10. The personalized device according to claim 9, wherein the trait profile is modifiable or disabled by means of a user selectable menu and a pointing device in communication with a processor of the personal computer, or is wirelessly modifiable.

11. The personalized device according to claim 1, wherein the reaction generator is operable to generate a reaction at a predetermined time.

12. The personalized device according to claim 1, wherein the reaction generator is operable to generate a reaction upon sensing motion or presence of the user, the motion or presence of the user is sensed by means of a voice sensor, a motion sensor, a presence sensor, a heat sensor for sensing body temperature, or a short range transceiver for receiving a signal transmitted by a suitable transmitter carried by the user.

13. The personalized device according to claim 1, wherein the case is made of a material selected from a group consisting of polymers, metals, metal alloys, wood, paper, cardboard, clay, glass, composite materials, leather, suede, velvet, textiles, silk, wool, hair, fur, a flexible screen, FOLED, or any combination thereof, and the size, shape, color, texture, and material of the envelope is individually selectable, customizable and/or formable.

14. The personalized device according to claim 1, wherein the case has a shape selected from a group consisting of animals, plants, people, celebrities, cartoon characters, vehicles, buildings and constructions, natural features, items of apparel, food products, balls, sports equipment, humanoids, robots, literary figures, biblical figures, abstract figures, furniture, households equipment, or any combination thereof.

15. The personalized device according to claim 1, wherein a plurality of cords extending from the device are guided through an aperture formed in a rear region of the case, to provide the appearance of a tail.

16. The personalized device according to claim 1, further comprising one or more replaceable and configurable parts which are attachable to the device, said parts having a shape selected from a group consisting of eyes, ears, nose, legs, wings, hats, shoes, socks, hats, clothes, decorations, or any combination thereof.

17. The personalized device according to claim 1, further comprising wired or wireless communicating means, said communicating means selected from the group consisting of RFID means, Bluetooth means, RF emitter, UV means, IR means, Vis light emitter, Laser emitter, radio transmitters and detectors thereof, networks, lines, internet, and intranet.

18. A community, comprising the personalized device according to claim 1 and at least one peripheral hardware unit, said at least one peripheral hardware unit comprising a three-dimensional user selectable case of varying shape which defines a figure of interest, a reaction generator, and sharing at least one common simulated personality trait with the device.

19. The community according to claim 18, wherein the at least one peripheral hardware unit is selected from group consisting of computers, personal computers, work stations, docking stations, laptops, PDAs, Personal Organizers, Communicators, imagers, screeners, printers, screens, displayers, slide projectors, projectors, modems, cables and communication cables, transformers, a mouse, mouse pads, keyboards, discs, hard disks, floppy disks, disk holders, loudspeakers, disk-on-keys, video sets, monitors, lamps, LEDs, play stations, media centers, projectors, telephones, cellular telephones, pagers, operators, servers, communication and power sockets, antennas, CD players, TV sets, radios, furniture, bags and carriages, or any combination thereof.

20. A community, comprising the personalized device according to claim 17 and at least one peripheral hardware unit, said at least one peripheral hardware unit comprising a three-dimensional user selectable case of varying shape which defines a figure of interest, a reaction generator, and wired or wireless communicating means for identifying each peripheral hardware unit, for communicating with the device, and for thereby acquiring a personality trait of the device, and sharing at least one common simulated personality trait with the device.

21. A personalized computer device, comprising:
a) a personal computer comprising processing means, motherboard, hard disk, and one or more user accessible hardware interfaces;
b) a user selectable, customizable and/or formable envelope enclosing said processing means, motherboard, and hard disk, said envelope designed in such a way that normal operation of said device by means of said one or more hardware interfaces remains unhindered; and
c) sound emitting means,
one or more desired personality traits being simulated by means of the combination of envelope shape and sounds emitted from said sound emitting means, whereby to establish an emotional attachment between a user and said device.

22. The personalized device according to claim 21, further comprising anchoring means for securing the envelope to a personal computer frame, said anchoring means being selected from a group consisting of magnets, screws, hooks, zippers, fasteners, clips, flaps, claspers, springs, grips, Velcro™, straps, strings, wires, cables, tabs, poppers, nails, buttons, brackets, or any combination thereof.

23. The personalized device according to claim 21, wherein the envelope is at least partially continuous and/or impermeable, and comprises at least one aperture, net-like or mesh-like opening.

24. The personalized device according to claim 21, further comprising a reaction generator, said reaction generator comprising a component selected from the group consisting of a sound emitter for enunciating a predetermined voice message, an actuator for initiating displacement of one or more elements operatively associated with the case, artificial intelligence means, means for customizing a displayed computer theme in response with a selected envelope shape, and means for displaying, introducing or emitting audio information, video information, light related information, sounds, or vibrations, or any combination thereof, one or more desired personality traits being simulated by means of the combination of a generated reaction and the shape of the case, so as to trigger an emotional response from the user.

25. A method for establishing an emotional attachment between a user and a personalized computer device, comprising the steps of selecting or customizing a case of a computer device which encloses its processing means, motherboard, and hard disk, and performing a device caused reaction in response to a predetermined event and in accordance with one or more predetermined reaction parameters, wherein said reaction simulates one or more desired personality traits that triggers an emotional response from a user and thereby establishes an emotional attachment between a user and the device.

26. The method according to claim 25, wherein the device caused reaction is selected from the group consisting of sound emission, light emission, video display, vibration emission, motor actuation, pump actuation, displacement of one or more elements operatively associated with the case, and customization of a displayed computer theme.

27. The method according to claim 25, wherein the one or more reaction parameters are acquired by communication means.
